(19) United States
(12) Patent Application Publication
(10) Pub. No.: US 2013/0067968 A1
(43) Pub. Date: Mar. 21, 2013

(54) CABLE RATCHET SECURITY DEVICE

(71) Applicant: Mark Ezzo, Tyler, TX (US)

(72) Inventor: Mark Ezzo, Tyler, TX (US)

(73) Assignee: CHECKPOINT SYSTEMS, INC., Thorofare, NJ (US)

(21) Appl. No.: 13/697,160

(22) PCT Filed: May 13, 2011
(86) PCT No.: PCT/US11/36400

§ 371 Date: Nov. 9, 2012

Related U.S. Application Data
(60) Provisional application No. 61/334,486, filed on May 13, 2010.

(51) Int. Cl. E05B 73/00

(52) U.S. Cl. CPC E05B 73/0017
USPC 70/57.1

(57) ABSTRACT

An example embodiment of the present invention includes a security device for secure attachment to an object. The security device comprises a housing, a cable, and a spool assembly. The cable defines an anchor end non-removably secured in the housing, a removable end, and a loop therebetween. The spool assembly is rotatably supported by, and at least partially enclosed within, the housing. The spool assembly defines a cable winding portion and a capture portion. The loop defines a first effective length when the removable end of the cable is received by the capture portion. The loop defines a second effective length smaller than the first effective length when the removable end of the cable is received by the capture portion and the spool assembly is rotated in a winding direction such that at least part of the cable is wound onto the cable winding portion of the spool assembly.

### FIELD

Embodiments discussed herein are related to a security device structured for attachment to an object. Such security devices often employ electronic article surveillance systems to deter and detect shoplifting.

### BACKGROUND

Deterring and preventing product theft is important in all retail environments. Balancing a desire for robust presentation and accessibility of retail products with proper security can be difficult. The development of electronic article surveillance (“EAS”) has helped deter retail theft while maintaining display options for retail products. In particular, tags or other security assemblies can be placed on products, and these tags may contain EAS, radio frequency identification (“RFID”), or other technologies that can track the product and set off an alarm if the article is being tampered with or removed from a designated area to deter retail theft.

Applicant has identified a number of deficiencies and problems associated with the manufacture, use, design, and operation of conventional security devices with EAS technology. Through applied effort, ingenuity, and innovation, Applicant has solved many of these identified problems by developing a solution that is embodied by the present invention, which is described in detail below.

### BRIEF SUMMARY OF THE INVENTION

It is desirable to protect retail products or articles from theft or unauthorized access. One form of protection from theft includes secure attachment of a security device to the article. In some cases, the security device may carry an EAS system configured to alarm when the article is being stolen or tampered with. However, security devices that employ EAS technology can often be bulky and obscure too much of the article, thereby making the article less accessible to customers and less likely to be purchased. The security device may obstruct or hinder desired manipulation of the article by a potential purchaser (e.g., trying on a pair of sunglasses). Finally, some security devices may be difficult for retail employees to properly attach and detach to retail articles.

Embodiments of the present invention provide improved apparatuses, systems, and methods for secure attachment of a security device to an article. In particular, embodiments as described herein are useful in attaching a security device to a retail article to avoid and/or deter theft of the article. Such embodiments further provide a security device that is compact in size, easily attached and detached, and adjustable so as to be readily configurable for attachment to articles of differing sizes and shapes.

In an example embodiment, a security device for secure attachment to an object is provided. The security device comprises a housing, a cable, and a spool assembly. The cable defines an anchor end, a removable end, and a loop therebetween. The anchor end is secured by the housing in a non-removable position. The spool assembly is rotatably supported by, and at least partially enclosed within, the housing. The spool assembly defines a cable winding portion and a removable end capture portion. The loop defines a first effective length when the removable end of the cable is received by the removable end capture portion. The loop further defines a second effective length that is smaller than the first effective length when the removable end of the cable is received by the removable end capture portion and the spool assembly is rotated in a winding direction such that at least part of the cable is wound onto the cable winding portion of the spool assembly.

In another embodiment, a security device for secure attachment to an object is provided. The security device comprises a housing, a security element, a cable, and a spool assembly. The cable is configurable between a capture position, wherein the cable defines a loop, and an un-captured position. The spool assembly is rotatably supported by, and at least partially enclosed within, the housing. The spool assembly defines a cable winding portion and a security element cavity configured to receive the security element. The loop defines a first effective length when the cable is disposed in the capture position. The loop further defines a second effective length that is smaller than the first effective length when the cable is disposed in the capture position and the spool assembly is rotated in a winding direction such that at least part of the cable is wound onto the cable winding portion of the spool assembly.

In another embodiment, a security device for secure attachment to an object is provided. The security device comprises a housing, a cable, and a spool assembly. The cable defines a loop between two ends of the cable, wherein each end is received within the housing. The spool assembly is rotatably supported by, and at least partially enclosed within, the housing. The spool assembly defines a cable winding portion and is configured to rotate in a winding direction such that at least part of the cable is wound on the cable winding portion. The loop defines a first effective length and a second effective length. The second effective length is smaller than the first effective length when at least part of the cable is wound onto the cable winding portion of the spool assembly. The loop defines the first effective length when the security device is in an unsecured state and the loop defines the second effective length when the security device is in a secured state. The object is securely engaged with the loop when the security device is in the secured state.

In another embodiment, a method for manufacturing a security device for secure attachment to an object is provided. The method comprises providing a housing and a cable defining an anchor end, a removable end, and a loop therebetween. The anchor end is secured by the housing in a non-removable position. The method further comprises providing a spool assembly rotatably supported by, and at least partially enclosed within, the housing. The spool assembly defines a cable winding portion and a removable end capture portion. The loop defines a first effective length when the removable end of the cable is received by the removable end capture portion. The loop further defines a second effective length that is smaller than the first effective length when the removable end of the cable is received by the removable end capture portion and the spool assembly is rotated in a winding direction such that at least part of the cable is wound onto the cable winding portion of the spool assembly.

In another embodiment, a method for manufacturing a security device for secure attachment to an object is provided. The method comprises providing a housing and a cable configurable between a capture position, wherein the cable defines a loop, and an un-captured position. The method further comprises providing a security element. The method further comprises providing a spool assembly rotatably supported by, and at least partially enclosed within, the housing. The spool assembly defines a cable winding portion and a security element cavity configured to receive the security element. The loop defines a first effective length when the cable is disposed in the capture position. The loop further defines a second effective length that is smaller than the first effective length when the cable is disposed in the capture position and the spool assembly is rotated in a winding direction such that at least part of the cable is wound onto the cable winding portion of the spool assembly.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a security device, in accordance with some embodiments discussed herein;

FIG. 2 is a detail view of a cable supporting a contact plate of the security device shown in FIG. 1, in accordance with some embodiments discussed herein;

FIG. 3 is a partial section of the security device of FIG. 1, taken along section line AA, in accordance with some embodiments discussed herein;

FIG. 4 is a partial section of the security device of FIG. 1, taken along section line BB, wherein the cable is removed from the housing, in accordance with some embodiments discussed herein;

FIG. 5 is a partial section of the security device of FIG. 1, taken along section line BB, wherein the cable is disposed in a capture position in the housing, in accordance with some embodiments discussed herein;

FIG. 5A is an end view of the spool assembly and cable shown in FIG. 5, in accordance with some embodiments discussed herein;

FIG. 6 is a partial section of the security device of FIG. 1, taken along section line BB, wherein the cable is partially wound around a spool, in accordance with some embodiments discussed herein;

FIG. 7 is an end view of the spool assembly, cable, and lock of the security device shown in FIG. 1, in accordance with some embodiments discussed herein;

FIG. 8 is a partial section of the security device shown in FIG. 1, taken along section line AA, which illustrates the locked position of the lock of the security device, in accordance with some embodiments discussed herein;

FIG. 9 is a perspective view of another embodiment of a security device, in accordance with some embodiments discussed herein;

FIG. 9A is an exploded view of the secondary housing of the security device shown in FIG. 9, in accordance with some embodiments discussed herein; and

FIG. 10 is a partial section of a security device, taken along section line AA of FIG. 1, in accordance with some embodiments discussed herein; and

FIG. 11 is a perspective view of a security device securely attached to an object, in accordance with some embodiments discussed herein.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

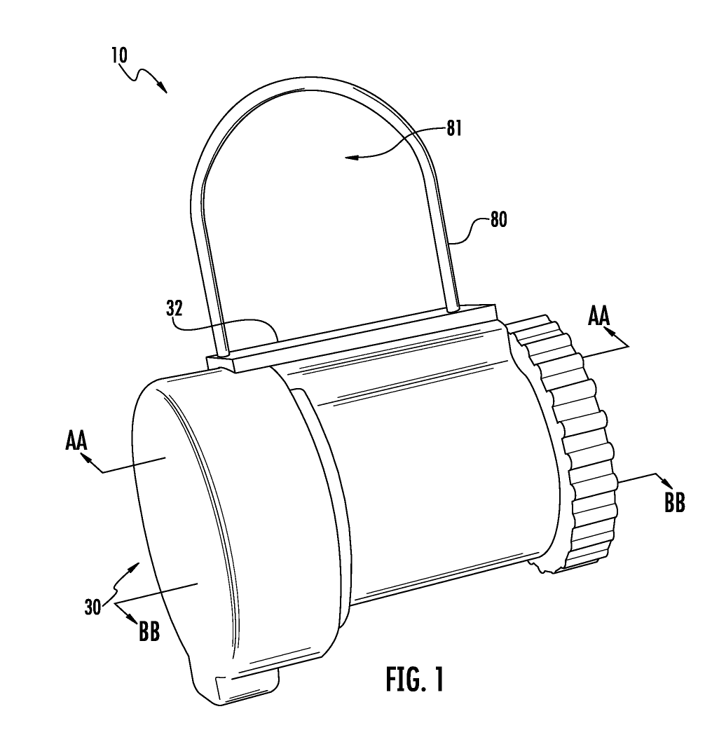

FIG. 1 shows a perspective view of a security device 10. The security device 10 may include an EAS element or other similar device (e.g., an RFID transponder, etc.) that may be used to detect and deter unauthorized removal of the security device 10 from a particular area such as a retail store. Thus, the security device 10 is meant to attach securely to an object (e.g., a retail article) so that an alarm sounds if the secured object is improperly removed from the retail establishment.

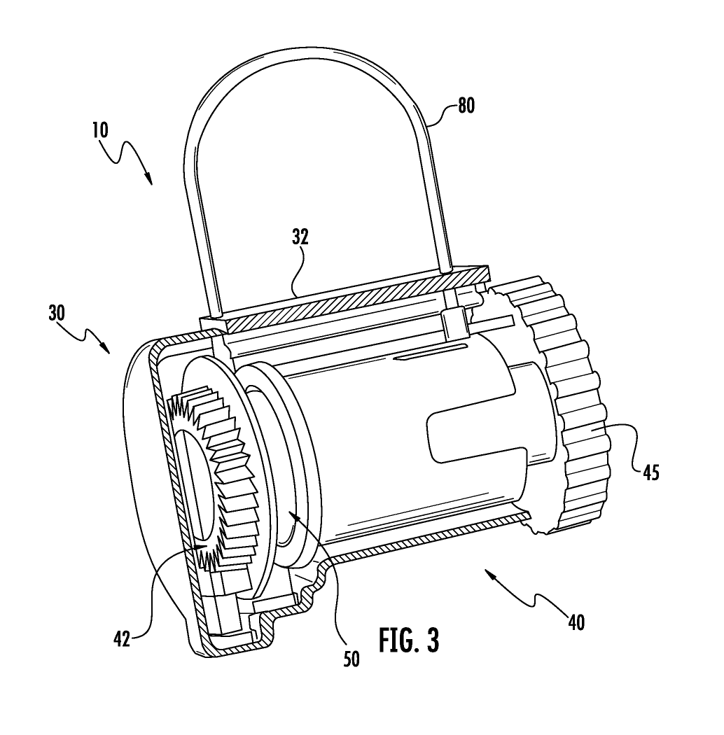

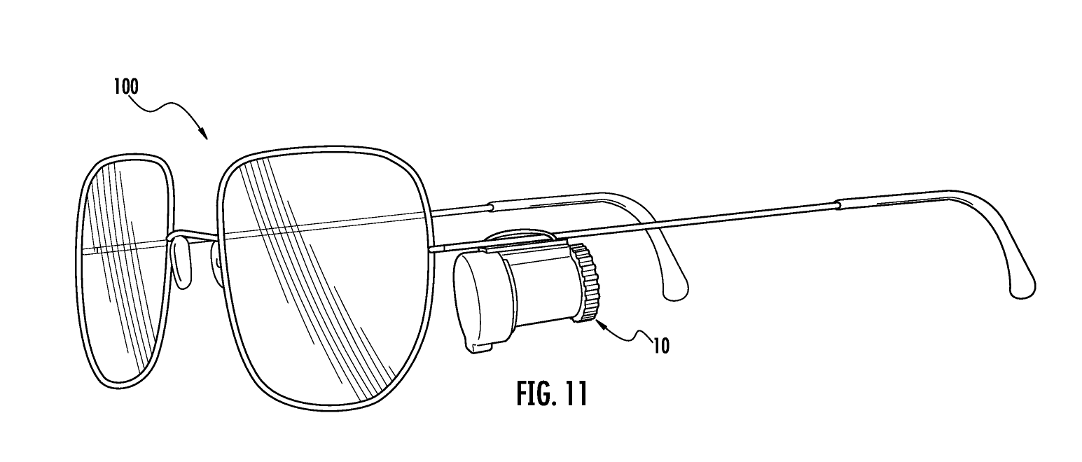

In the depicted embodiment of FIG. 1, the security device 10 comprises a housing 30, a cable 80 defining a loop 81, and a spool assembly 40 (shown in FIG. 3) for winding the cable 80 and thereby adjusting the effective length of the loop 81 for attachment to articles of differing sizes and shapes, as will be discussed in greater detail below. The depicted security device 10 includes a contact plate 32 that is configured to contact an attached retail article (shown in FIG. 11) and distribute a load across a larger surface area of the article (e.g., as compared to the cable 80 or housing 30 alone) to reduce stress and damage to the article. In alternative embodiments, the contact plate 32 may not be used and the cable 80 and housing 30 may be the sole means provided for contacting the article during attachment.

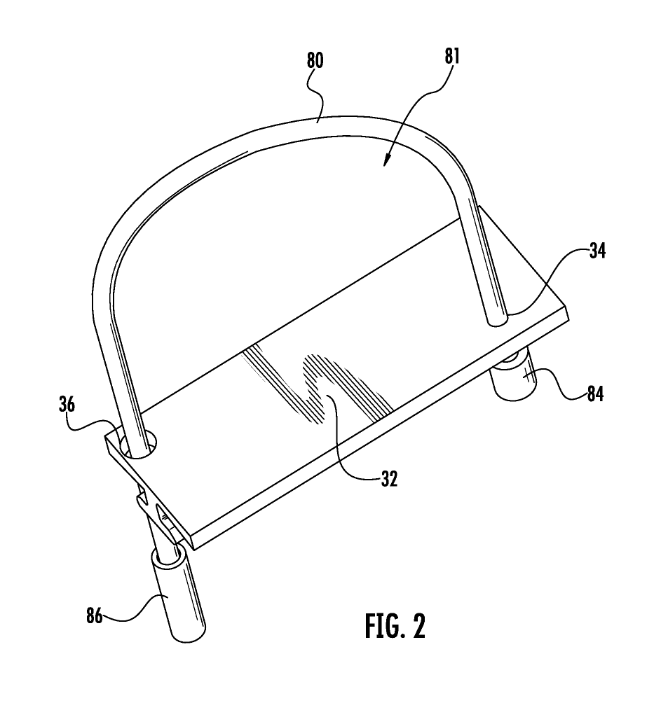

FIG. 2 shows a detail view of the contact plate 32 of the housing 30 and the cable 80. In the depicted embodiment, the cable 80 defines an anchor end 84 and a removable end 86. The anchor end 84 may be configured to have a wider portion, such as a portion having an increased diameter, so as to retain the cable 80 within the housing 30 (shown in FIG. 1). Additionally, the removable end 86 may also be configured to have a wider portion so as to retain the cable 80 within the housing 30 when engaged and to prevent its removal through certain holes in the security device 10, as described below. In various embodiments, the removable end 86 of the cable 80 may be smaller in size than the anchor end 84, such that the removable end 86 may be able to pass through certain size holes, while the anchor end 84 may not fit through holes of a similar size. In some embodiments, the removable end 86 may be fixed inside the housing 30 and thereby unable to be removed from the housing 30.

In the depicted embodiment of FIG. 2, the contact plate 32 defines an anchor opening 34 that allows the cable 80 to pass through the contact plate 32. However, the anchor end 84 of the cable 80 may be structured (e.g., the wider portion) such that it cannot be pulled out of the anchor opening 34, thus keeping the cable 80 anchored to the central housing 30. Additionally, the contact plate 32 may define a spool side opening 36, which is sized to allow the removable end 86 of the cable 80 to pass into and out of the housing 30 through the contact plate 32. In various embodiments, the anchor opening 34 and the spool side opening 36 may be defined in the housing 30 itself (e.g., when a contact plate 32 is not provided). Therefore, as can be seen with reference to FIGS. 1 and 2, the cable 80 is designed to be anchored inside the housing 30 at the anchor end 84 and configured to be threaded into the central housing 30 via the removable end 86.

FIG. 3 shows a perspective view of the security device 10 taken along line AA of FIG. 1 having a partially sectioned housing 30. In some embodiments, the spool assembly 40 comprises a spool 50, which may be rotatably supported by, and at least partially enclosed within, the housing 30. The spool 50 may be configured to rotate to take-up at least a portion of the cable 80. In some embodiments, the spool 50 may be configured to capture at least a portion of the cable 80 proximate the removable end 86 to facilitate winding of the cable 80 onto the spool 50.

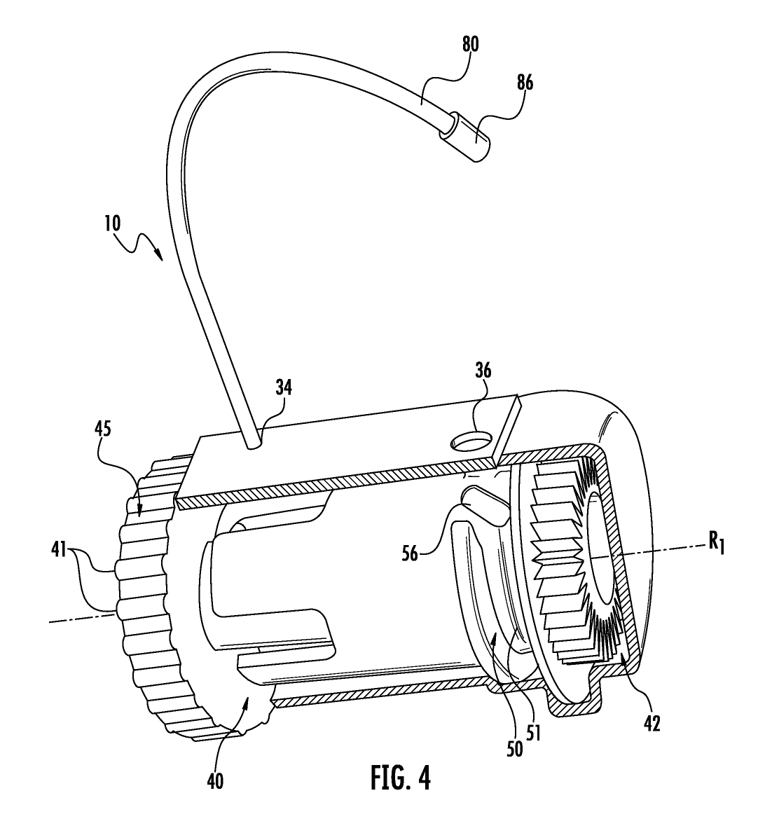

FIGS. 4, 5, and 6 show perspective views of the security device 10 taken along line BB of FIG. 1 having a partially sectioned housing 30. In particular, FIGS. 4-6 illustrate different configurations of the security device 10 as the cable 80 is threaded into the housing 30 and wound around the spool 50. In various embodiments, as will be described in greater detail herein, the security device 10 uses the spool assembly 40 and cable 80 to achieve secure attachment to an object. As will be apparent to one of ordinary skill in the art in light of this disclosure, other wrapable materials could be used instead of cable, such as ribbon, wire, ziptie-type materials and the like.

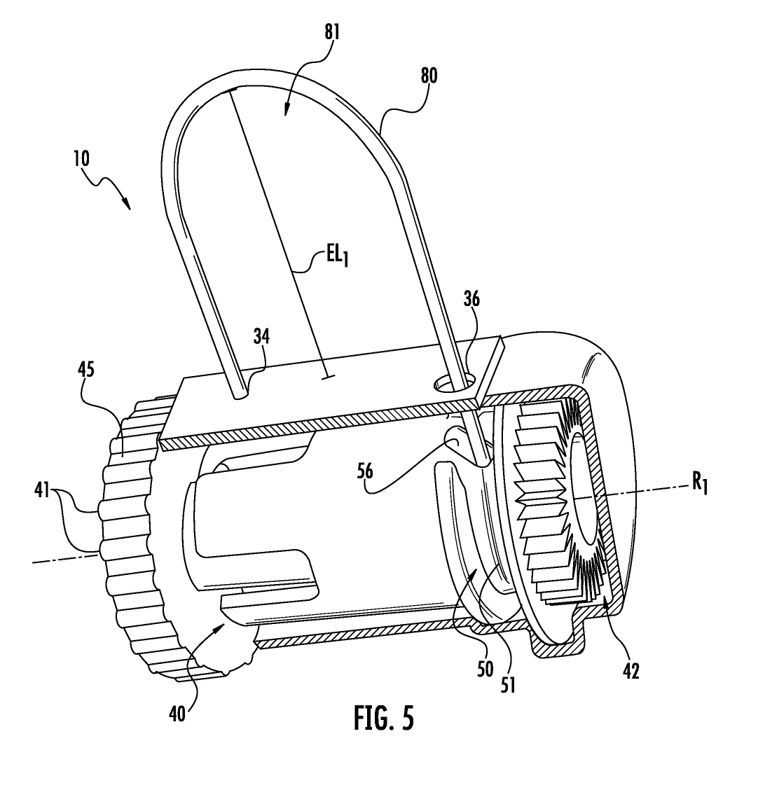

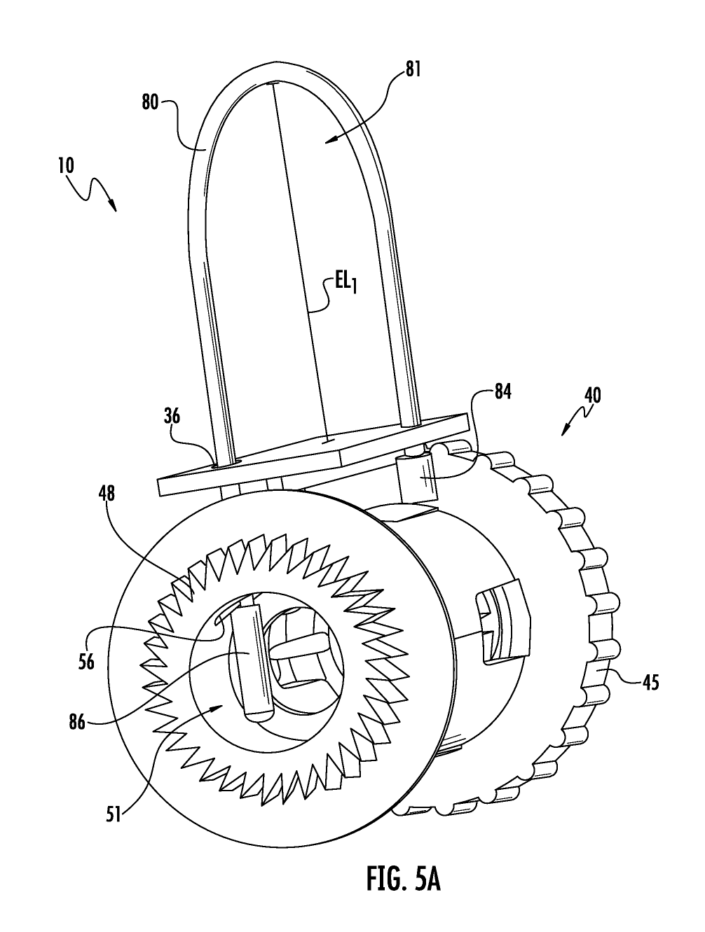

With reference to FIG. 4, the cable 80 may define an uncaptured position when the removable end 86 of the cable 80, is removed from the housing 30 and/or the spool 50. In the uncaptured position, the cable 80 may be wrapped around an object (such as object 100 shown in FIG. 11). Then, the removable end 86 of the cable 80 may be threaded through the spool-side opening 36 and into the housing 30. Additionally or alternatively, the spool 50 may be structured with an angled opening 56, or capture portion. The angled opening 56 may be configured to allow the removable end 86 of the cable 80 to be threaded inside the spool 50. In some embodiments, the angled opening 56 may be configured with an extended and/or angled opening for ease of insertion of the removable end 86. With reference to FIG. 5A, the removable end 86 of the cable 80 may be threaded through the angled opening 56 and inside a central cavity 51 of the spool 50. With the removable end 86 of the cable 80 positioned through the angled opening 56, the cable 80 is in the capture position. As shown in FIG. 5, with the cable 80 displaced in the captured position, the loop 81 formed by a portion of the cable 80 between the spool-side opening 36 or angled opening 56 and the anchor opening 34 may define a first effective length EL₁. In some embodiments, the loop 81 may define the first effective length EL, when the removable end 86 of the cable 80 is inserted into and/or received by a removable end capture portion (e.g., the angled opening 56). Additionally or alternatively, the loop 81 may define the first effective length EL₁ when the cable 80 is disposed in the capture position. In some embodiments, when the loop 81 of the cable 80 is positioned around at least a portion of an object, the first effective length EL₁ may correspond to an at least partially loosened state of the loop 81 around the object (not shown). In such a configuration, in some embodiments, the object may be passed into and/or out of the loop 81 when the loop 81 defines the first effective length EL₁.

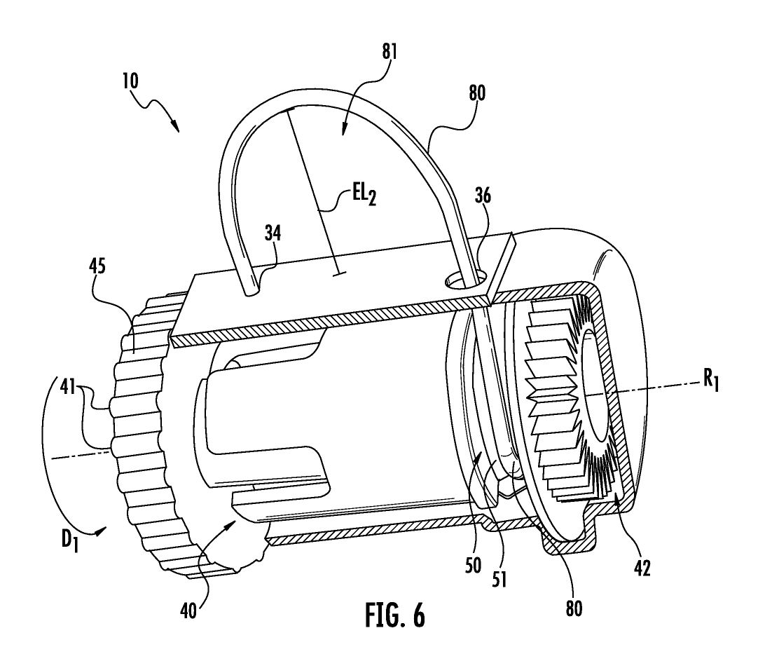

The spool 50 may be configured to rotate to take-up at least a portion of the cable 80 when the removable end 86 of the cable 80 is received by the angled opening 56 (e.g., when the cable 80 is disposed in the capture position). With reference to FIGS. 5 and 6, the spool 50 may define a cable winding portion 51 configured to collect the cable 80 as the spool 50 is rotated in the winding direction D₁ (shown in FIG. 6) around a rotational axis R₁. When the spool assembly 40 and/or spool 50 is turned, the removable end 86 of the cable 80, because of the size and shape of the angled opening 56, bends abruptly and remains inside the spool assembly 40. Said differently, a kink is created in the cable 80 and/or removable end 86 by the force of the edge of the angled opening 56 against the cable 80, and the removable end 86 is maintained inside the angled opening 56 when the spool assembly 40 and/or spool 50 are turned. This kink allows the removable end 86 of the cable 80 to be more securely held within the spool 50 despite the relatively high forces applied to the cable 80 during winding.

As shown in FIG. 6, rotation of the spool assembly 40 and/or spool 50 in the winding direction D₁ engages the cable 80, forcing the cable 80 to collect around the cable winding portion 51. In the depicted embodiment, a portion of the cable 80 is collected on the cable winding portion 51 as the spool 50, and the angled opening 56, are rotated in the winding direction D₁. As such, the loop 81 may define a second effective length EL₂ that is smaller than the first effective length EL₁. For example, in the depicted embodiment, the second effective length EL₂ defines a distance between the housing 30 and the top arc of the loop 81 of the cable 80 that is smaller than the distance between the housing 30 and the top arc of the loop 81 of the cable 80 of the first effective length EL₁ (shown in FIG. 5). In various embodiments, the length of the inner surface of the portion of the cable 80 forming a loop between the anchor opening 34 and the spool-side opening 36 may define the first and/or second effective length. Thus, in some embodiments, the length of the second effective length may be less than the length of the first effective length since a portion of the cable 80 may be wound on the spool 50 inside the housing 30.

In some embodiments, the loop 81 may define the second effective length EL₂ when the removable end 86 of the cable 80 is received by a removable end capture portion (e.g., the angled opening 56) and the spool 50 is rotated in the winding direction D₁ such that at least a part of the cable 80 is wound on the cable winding portion 51. Additionally or alternatively, the loop 81 may define the second effective length EL₂ when the cable 80 is disposed in the capture position and the spool 50 is rotated in the winding direction D₁ such that at least a part of the cable 80 is wound on the cable winding portion 51. In some embodiments, when the loop 81 of the cable 80 is positioned around at least a portion of an object, the second effective length EL₂ may be defined by an at least partially tightened state of the loop 81 (e.g., with respect to the first effective length EL₁) around the object (not shown). In such a configuration, in some embodiments, the cable 80 may be tightened around at least a portion of the object such that the object is unable to be detached from the security device.

In some embodiments, the security device 10 may be configurable between a secured state and unsecured state. For example, the security device 10 may be in an unsecured state when the loop 81 defines the first effective length EL₁. When the security device 10 is in the unsecured state, the cable 80 may be relatively loose around the object such that a user may be able to insert the object through the loop 81 to attach the security device 10 to the object and/or may be able to remove the object from engagement with the loop 81 to detach the security device 10 from the object. In the secured state, the loop 81 of the security device 10 may define the second effective length EL₂, which as noted above is smaller than the first effective length EL₁. Thus, when the security device 10 is in the secured state, the cable 80 may be relatively tight around the object such that the object may not be removed from attachment with the security device 10, as shown in FIG. 11.

As such, the object may be securely engaged with and/or attached to the security device 10 when the security device 10 is in the secured state. For example, in embodiments in which the removable end 86 of the cable 80 is removable from the housing 30, the cable may be wrapped around or otherwise engaged with the object when the removable end 86 is in the uncaptured position, and then the removable end 86 may be inserted into the housing as described above. At this point, the cable 80 may not be securely engaged with the object (e.g., the cable may be loosely wrapped about the object) as the security device 10 may still be in the unsecured state. The cable 80 may then be tightened as described herein to achieve the secured state in which the cable 80 defines the second effective length EL₂, thereby securely engaging the object. In other embodiments in which both ends 84, 86 of the cable 80 are fixed within the housing 30 (e.g., not removable from within the housing), the object may be engaged with the security device 10 when the security device is in the unsecured state, for example by passing the object (or a portion of the object) through the larger first effective length EL₁, then tightening the cable 80 to achieve the secured state in which the cable 80 defines the second effective length EL₂, as described herein.

The spool assembly 40 and/or spool 50 may also be rotated in the opposite direction (e.g., the unwinding direction). In some embodiments, as the spool 50 is rotated in the unwinding direction, the cable 80 is at least partially removed and/or unwound from the cable winding portion 51. Additionally or alternatively, continued rotation in the unwinding direction may cause the angled opening 56 to align with the spool-side opening 36 such that the removable end 86 of the cable 80 can be removed from the spool 50 and/or housing 30.

In some embodiments, the spool assembly 40 may comprise a grip 45. The grip 45 allows a user to rotate the spool assembly 40 and/or spool 50, such as with the user's fingers, around rotational axis R₁. As such, a user may control when the desired length of the cable 80 and/or second effective length EL₂ of the loop 81 is reached so that the security device 10 is properly secured to the object. In particular, the grip 45 may be configured for engagement by a user to rotate the spool 50 and/or spool assembly 40. For example, in some embodiments, the grip 45 may comprise nodules, ribs, or other features 41 that are configured, such as through friction, to aid a user in rotating the spool assembly 40 and/or spool 50.

In some embodiments, the spool assembly 40 may comprise a ratchet portion 42. The ratchet portion 42 may comprise receiving teeth 48. In the depicted embodiment, the ratchet portion 42 is disposed proximate a first end of the spool assembly 40 and the grip 45 is disposed proximate a second end of the spool assembly 40. Thus, rotation of the spool assembly 40 and/or spool 50 may cause rotation of the ratchet portion 42.

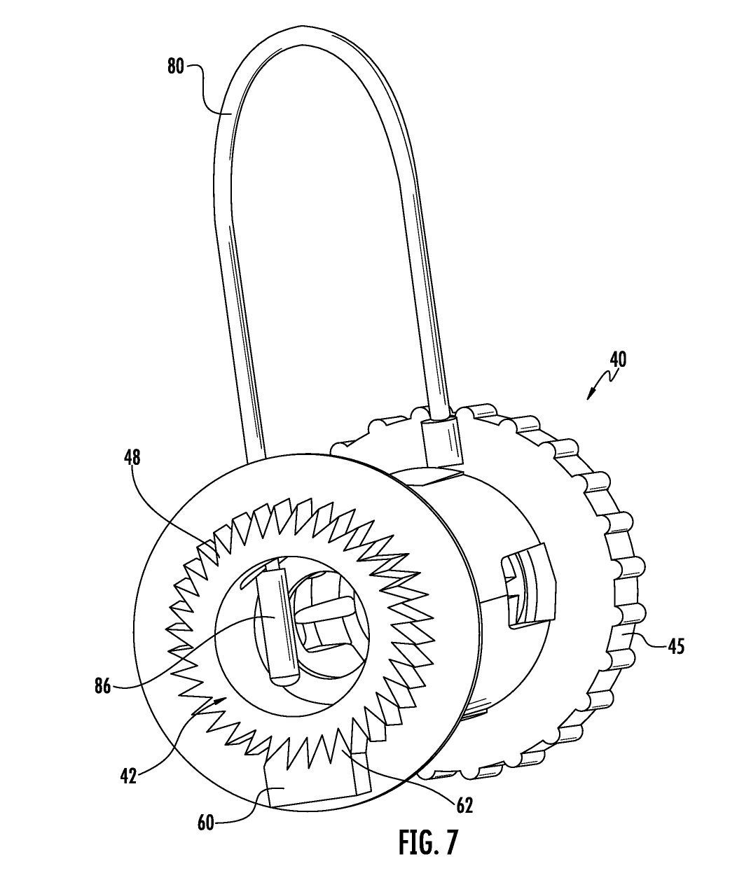

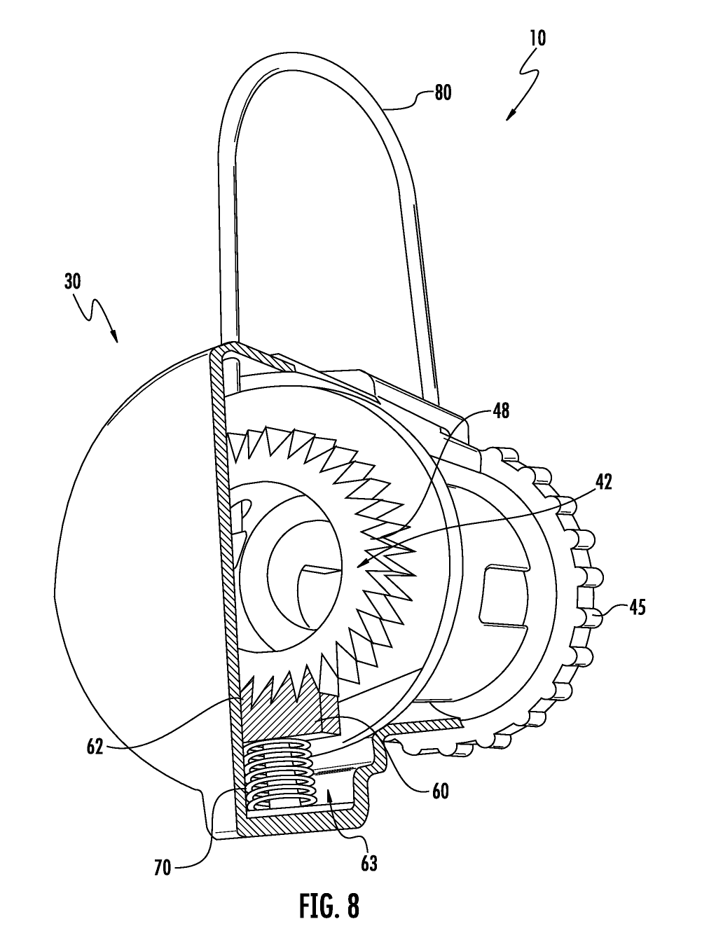

In some embodiments, the security device 10 may define a locked configuration and an unlocked configuration. Thus, the housing 30 of the security device 10, in various embodiments, may comprise a lock 60 (shown in FIG. 7). In the depicted embodiment, the receiving teeth 48 of the ratchet portion 42 are selectively engaged by a lock 60 when the security device 10 is disposed in the locked configuration. In some embodiments, the lock 60 is comprised of at least one locking tooth 62, wherein the locking tooth 62 is configured to engage with the receiving teeth 48 to prevent reverse rotation of the spool assembly 40 (e.g., rotating of the cable 80 in the unwinding direction) when the security device 10 is locked. In some embodiments, the lock 60 may comprises a plurality of locking teeth 62. In various embodiments, even when the ratchet portion 42 is engaged with the lock 60 in the locked configuration, as shown in FIGS. 7 and 8, with the locking teeth 62 securely engaging the receiving teeth 48, the spool assembly 40, including the ratchet portion 42, may still be further rotated so as to tighten (e.g., continue winding) the cable 80. As will be apparent to one of ordinary skill in the art, one way rotation of this kind may be facilitated by providing a taper to the receiving teeth 48 as shown. In some embodiments, as can be seen in FIG. 8, the lock 60 may be biased in the locked position by a spring 70. Thus, as will be apparent to one of ordinary skill in the art in light of the this disclosure, the security device 10 may be biased in the locked configuration.

FIG. 8 shows a perspective view of the security device 10 having a partially sectioned housing 30. The housing 30, in the depicted embodiment, is configured to allow the lock 60 to extend to engage the receiving teeth 48 when in the locked configuration. Additionally, the housing 30 is configured to allow the lock 60 to retract into a cavity 63 defined in the housing 30. This retraction of the lock 60 occurs either when the spool assembly 40 is turned so as to tighten the cable 80 (i.e., intermittent partial retracting as produced by the receiving teeth taper) or when the security device 10 is unlocked by a magnetic key (not shown). To unlock the security device 10, a magnetic key (not shown) can be placed proximate to the side of the lock 60 opposite the locking teeth 62. The lock 60 can be composed of a ferrous material such that placing the magnetic key in the proper location (e.g., applying a magnetic field to a pre-determined location) forces the lock 60 to retract toward the spring 70, thereby removing the locking teeth 62 from their engagement with the receiving teeth 48. This allows the spool assembly 40 and/or spool 50 to rotate freely (e.g., in the unwinding direction), and the cable 80 to be released, thus releasing the object from its secured position. With the magnetic key holding the lock 60 in a retracted position, the cable 80 can either be pulled out of the housing 30 or the spool assembly 40, and can be manually rotated in the unwinding direction, so as to unwind the cable 80 from around the spool 50 and/or cable winding portion 51. Once the cable 80 is unwound, the removable end 86 can be taken out of the angled opening 56 in the spool 50 and also out of the spool-side opening 36 of the housing 30.

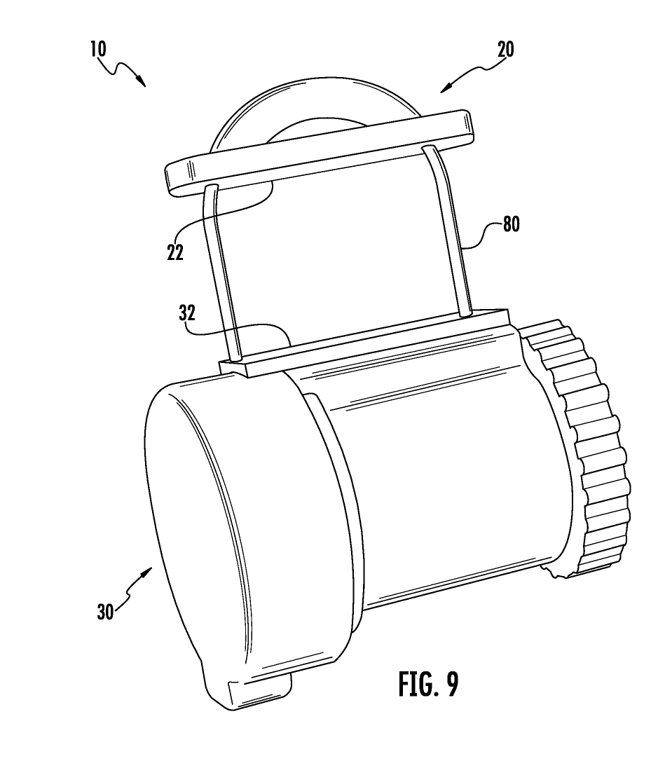

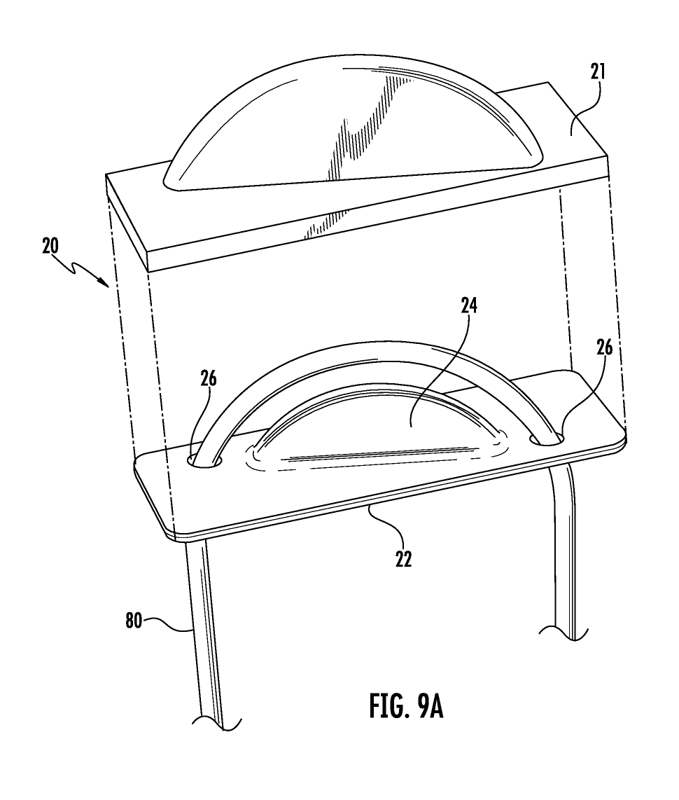

FIG. 9 illustrates another embodiment of the security device 10. In the depicted embodiment, the security device 10 comprises a secondary housing 20 in addition to the housing 30 and the cable 80. The cable 80 may be structured to pass from the housing 30 through the secondary housing 20, around the object and back into the housing 30.

FIG. 9A shows an exploded view of the secondary housing 20 of a security device 10, wherein a portion 21 of the secondary housing 20 has been displaced to show internal components of the secondary housing 20. In the depicted embodiment, the secondary housing 20 comprises a secondary contact plate 22 and a guide flange 24. The guide flange 24 is structured so as to guide the cable 80 through the secondary housing 20 so that the cable 80 can curve across the secondary contact plate 22. As such, the weight of the cable 80 may be spread across the secondary contact plate 22 when it is tightened around an object thereby avoiding a concentration of force in only certain areas of the secondary contact plate 22.

For example, the secondary housing 20 may be structured to allow the cable 80 to pass through the secondary contact plate 22 via cable holes 26. The cable holes 26 of the secondary housing 20 may be configured to allow only the cable 80 to pass through, such that once the end features of the cable (e.g., the wider portions of the anchor end 84 and the removable end 86) are attached to the cable 80, the wider portions are not able to pass through the cable holes 26 and, thus, the cable 80 cannot be removed from the secondary housing 20. In some embodiments, however, the cable holes 26 may be sized large enough to allow the removable end 86 of the cable 80 to pass through so as to facilitate easy replacement of differently configured secondary housings 20. For example, a user could remove the cable 80 from secondary housing 20 and feed the cable 80 through a different secondary housing for subsequent attachment to another object.

In the depicted embodiment of FIG. 9, the secondary housing 20 and the housing 30 are structured to clamp down on the object to secure it. The secondary contact plate 22 is structured to engage the object meant to be secured. Additionally, the contact plate 32 of the housing 30 may be configured to oppose the secondary contact plate 22. For example, the secondary contact plate 22 and the contact plate 32, as shown in FIG. 9, may define opposed flat surfaces so as to engage a flat object. The flat surfaces of the contact plates 22, 32 may also help to evenly distribute the force of the cable 80 over a larger surface area of the object when it is engaged with the contact plates to more securely hold the object in place (e.g., to frictionally engage the object over a larger surface area of the contact plate that is in contact with the object). Additionally, as will be apparent to one of ordinary skill in the art in view of this disclosure, the contact plates 22, 32 may be designed in other manners to engage differently shaped objects securely (e.g., with a convex or concave shape). For example, the shape of the contact plates 22, 32 may correspond to the shape of an engaging portion of the object. Furthermore, the contact plates 22, 32 may be made with a friction enhancing material, such as rubber or other impressionable material, so that they more securely engage the object, thereby allowing for inconsistencies in the textures of the object. In this regard, the rubber or other impressionable material may be flexible, thus allowing the contact plates to be firmly tightened around the object and ratcheted to full tightness without damaging or breaking the object. In other embodiments, additional contact plates may be added to the security device 10 such that multiple objects, or objects with multiple parts, may be properly secured.

In one or more of the embodiments discussed above, the security device 10 may further include anti-theft features configured to provide one or more alerts in the event the security device 10 is bypassed or the object being secured is moved out of a specified area. For example, the anti-theft features may provide one or more of the following alerts: (1) activation of an alarm (audible and/or visual) at the location of a security gate (i.e., a gate alarm) when the object with the security device is physically moved through the security gate; (2) activation of an alarm (audible and/or visual) actually located inside or on the security device that is attached to the object when the object is physically moved through the security gate; and (3) activation of an alarm (audible and/or visual) in the security device when an attempt has been made to tamper with or bypass the locking mechanism (i.e., either the cable or the lock) of the security device. Details regarding methods and devices for providing such three alarm security are described in U.S. Publication No. 2006/0145848 entitled “Electronic Security Device and System for Articles of Merchandise,” U.S. Pat. No. 7,474,209 entitled “Cable Alarm Security Device,” and U.S. Pat. No. 7,497,101 entitled “Cable Wrap Security Device,” the contents of each of which are incorporated by reference herein.

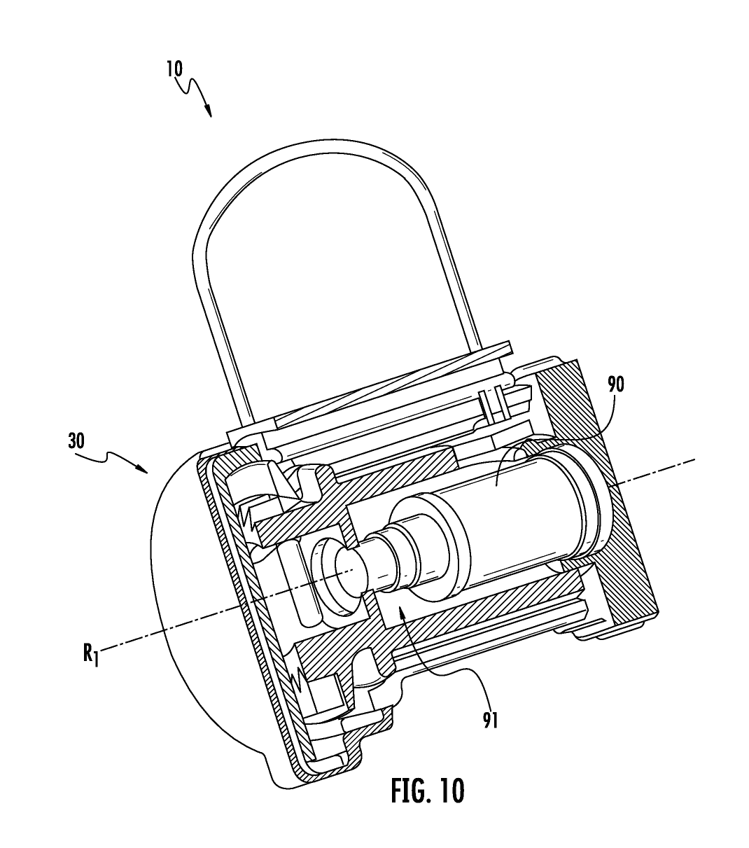

With reference to FIG. 10, a security device 10 (which may be, for example, any one of the security devices described above) is shown having a housing 30 that includes a security element 90 inside the housing 30. In some embodiments, the spool assembly 40 and/or spool 50 may define a cavity 91 for receiving the security element 90. Additionally or alternatively, the spool 50 may define a rotational axis R₁ and the security element cavity 91 may be defined about the rotational axis R₁. In such an embodiment, the security element 90 may be configured to rotate with the spool 50 around the rotational axis R₁. The security element 90 may be one of any number of devices that is configured to be detected by a security system, such as an RFID transponder (e.g., an active tag, a passive tag, etc.) or an Electronic Article Surveillance (EAS) element. Considering the example of an EAS security element 90, shown in FIG. 10, the EAS element may be configured to be detectable when the EAS element is present in a predetermined detection zone, such as a zone set up at or near the door or other entrance point of a warehouse or distribution center. The EAS element may be configured to work within an EAS security system. For example, the EAS element may include a magnetic tag, such as those used in an electromagnetic (EM) system or in an acousto-magnetic (AM) system. As another example, the EAS element may be configured work within a microwave system.

Referring to FIG. 10, in some cases, the housing 30 may include other security or alarm features. For example, the housing 30 may have an audible alarm device, such as a piezoelectric speaker, which may be triggered in response to one or more circumstances. In some embodiments, the housing 30 may thus include a printed circuit board with a logic circuit, a sense loop configured to detect a fault condition associated with the security device 10 (i.e., tampering with or bypassing the security device), and/or an energy source, such as a battery. The logic circuit may be disposed in communication with at least a portion of the security device 10 described in various embodiments above to form a sense loop configured to detect a fault condition associated with the security device 10. In this way, any discontinuity (e.g., cutting of the cable 80 in or unexpected movement of the lock 60 in FIG. 6) in the sense loop may be recognized as a fault condition, which triggers alarm functionality as described in greater detail herein.

Thus, according to the embodiments shown in FIG. 10, the housing 30 may include components that provide 1-alarm (e.g., alarming by a security gate at the security gate when the object is improperly moved past the gate), 2-alarm (e.g., alarming at the security gate when the object is moved and alarming by the security device attached to the object when the security device is tampered with or compromised), or 3-alarm (e.g., alarming at the security gate when the object is moved and alarming by the security device attached to the object when the security device is tampered with or compromised and alarming by the security device attached to the object when the object is improperly moved past the security gate) functionality to the security device and attached object.

In various embodiments, as illustrated in FIG. 11, the security device 10 may be configured to define a compact design. For example, the security device 10 could be made to be wound with a user's fingers and, thus, may be no more than 1-2 inches in width. This compact design allows the security device 10 to engage and secure smaller objects such as eyeglasses 100, and in particular, the portion of the eyeglasses that extend from the frame over a wearer's ear (e.g., the eyeglass temples). The compact embodiment of the security device 10 can be configured for placement over the eyeglass portion described above, so that a user's finger can ratchet and lock the cable 80 around the eyeglasses. This way, the security device 10 can remain on the eyeglasses 100 while a shopper tries them on, thereby enabling the shopper to properly evaluate the eyeglasses 100 for possible purchase.

As will be apparent to one of ordinary skill in the art in view of the disclosure, embodiments of the security device described herein may be useful for methods for securing a security device to an object. Moreover, embodiments of the present invention may include methods for manufacturing a security device for secure attachment to an object, wherein the security device may comprise any and/or all of the embodiments described herein.

Many modifications and other embodiments of the inventions set forth herein will come to mind to one skilled in the art to which these inventions pertain having the benefit of the teachings presented in the foregoing descriptions and the associated drawings. For example, although embodiments described above include a ratchet, other embodiments are contemplated that use other mechanisms for decreasing the effective length of the loop to secure an object. Such mechanisms may include other features to engage the spool assembly 40 to control and/or lock the effective length of the loop (e.g., a spring-biased pin configured to engage one of a plurality of holes positioned along the circumference of the spool assembly). Therefore, it is to be understood that the inventions are not to be limited to the specific embodiments disclosed and that modifications and other embodiments are intended to be included herein. Although specific terms are employed herein, they are used in a generic and descriptive sense only and not for purposes of limitation.

1. A security device for secure attachment to an object, the security device comprising:
a housing;
a cable defining an anchor end, a removable end, and a loop therebetween, wherein the anchor end of the cable is secured by the housing in a non-removable position; and
a spool assembly rotatably supported by, and at least partially enclosed within, the housing, the spool assembly defining a cable winding portion and a removable end capture portion,
wherein the loop defines a first effective length when the removable end of the cable is received by the removable end capture portion, and wherein the loop defines a second effective length that is smaller than the first effective length when the removable end of the cable is received by the removable end capture portion and the spool assembly is rotated in a winding direction such that at least part of the cable is wound onto the cable winding portion of the spool assembly.

2. The security device of claim 1, wherein the spool assembly further defines a grip portion configured for engagement by a user to rotate the spool assembly.

3. The security device of claim 1, wherein the spool assembly further defines a ratchet portion.

4. The security device of claim 3, wherein the spool assembly further defines a grip portion configured for engagement by a user to rotate the spool assembly.

5. The security device of claim 4, wherein the ratchet portion is disposed proximate a first end of the spool assembly and the grip portion is disposed proximate a second end of the spool assembly.

6. The security device of claim 3 further comprising a lock that is configurable between a locked position, wherein the lock engages the ratchet portion of the spool assembly to prevent rotation of the spool assembly in an unwinding direction, and an unlocked position.

7. The security device of claim 6, wherein the lock comprises at least one locking tooth configured to engage receiving teeth defined by the ratchet portion.

8. The security device of claim 7, wherein the at least one locking tooth is tapered to allow rotation of the spool assembly in the winding direction and to resist rotation in the unwinding direction when the lock is disposed in the locked position.

9. The security device of claim 6, wherein the lock is biased towards the locked position.

10. The security device of claim 9, wherein at least a portion of the lock comprises a ferrous material, and wherein the lock is configured to be moved to the unlocked position to allow rotation of the spool in the unwinding direction upon application of a magnetic field in a pre-determined location.

11. The security device of claim 1, wherein the removable end capture portion comprises a cavity defined in the spool assembly.

12. The security device of claim 1 further comprising a security element, wherein the spool assembly defines a security element cavity configured to receive the security element.

13. The security device of claim 12, wherein the spool assembly defines a rotational axis, and wherein the security element cavity is defined about the rotational axis.

14. The security device of claim 13, wherein the security element is configured to rotate with the security element cavity around the rotational axis.

15. The security device of claim 1 further comprising a secondary housing configured to receive at least a portion of the cable and configured to contact at least a portion of the object when the loop defines the second effective length.

16. The security device of claim 15, wherein the secondary housing comprises a contact plate defining a surface area configured to contact the object, and wherein the contact plate is configured to distribute the force of the cable on the object over the surface area.

17. The security device of claim 1, wherein the cable is configurable between a capture position, wherein the cable defines the loop, and an un-captured position.

18. The security device of claim 17, wherein the loop defines the first effective length when the cable is disposed in the capture position, and wherein the loop defines the second effective length when the cable is disposed in the capture position and the spool assembly is rotated in the winding direction such that at least part of the cable is wound onto the cable winding portion of the spool assembly.

19-35. (canceled)

36. A method for manufacturing a security device for secure attachment to an object, the method comprising:
providing a housing;
providing a cable defining an anchor end, a removable end, and a loop therebetween, wherein the anchor end is secured by the housing in a non-removable position; and
providing a spool assembly rotatably supported by, and at least partially enclosed within, the housing, the spool assembly defining a cable winding portion and a removable end capture portion, wherein the loop defines a first effective length when the removable end of the cable is received by the removable end capture portion, and wherein the loop defines a second effective length that is smaller than the first effective length when the removable end of the cable is received by the removable end capture portion and the spool assembly is rotated in a winding direction such that at least part of the cable is wound onto the cable winding portion of the spool assembly.

37-73. (canceled)

74. A security device for secure attachment to an object, the security device comprising:
a housing;
a cable defining a first end, a second end, and a loop therebetween, wherein the second end of the cable is secured by the housing so as to be non-removable from the housing;
a spool assembly rotatably supported by the housing and configured to rotate about an axis, wherein the spool assembly is configured to removably receive the first end of the cable, wherein spool assembly defines a cable winding portion configured to receive at least a portion of the cable when the first end is received by the spool assembly and the spool assembly is rotated in a winding direction, wherein the spool assembly defines a security element cavity about the axis; and
a security element disposed in the security element cavity and configured to rotate with the spool assembly about the axis,
wherein the loop defines a first effective length when the first end of the cable is received by the spool assembly, and wherein the loop defines a second effective length that is smaller than the first effective length when the first end of the cable is received by the spool assembly and the spool assembly is rotated in the winding direction such that at least part of the cable is wound onto the cable winding portion.
